(19) United States
(12) Patent Application Publication
(10) Pub. No.: US 2024/0084557 A1
(43) Pub. Date: Mar. 14, 2024

(54) DISPLAY SYSTEM OF WORK MACHINE

(71) Applicant: KOMATSU LTD., Minato-ku, Tokyo (JP)

(72) Inventor: Ryohei KIKUZAWA, Minato-ku, Tokyo (JP)

(73) Assignee: KOMATSU LTD., Minato-ku, Tokyo (JP)

(21) Appl. No.: 18/274,787

(22) PCT Filed: Feb. 4, 2022
(86) PCT No.: PCT/JP2022/004523

§ 371 Date: Jul. 28, 2023

(30) Foreign Application Priority Data
Feb. 16, 2021 (JP) 2021-022391

(51) Int. Cl. E02F 9/26; E02F 9/20

(52) U.S. Cl. CPC E02F 9/264; E02F 9/2012; E02F 9/261

(57) ABSTRACT

An actuator drives a hydraulic excavator. A switch apparatus makes a switch between a supply state in which the actuator can be driven and a shut-off state in which the actuator cannot be driven. A display apparatus is capable of switching between displaying a third screen (setting screen) for setting an operational property of the actuator and displaying an information display screen different from the third screen, in the shut-off state. A controller performs control to cause the display apparatus to continue displaying the third screen in both the shut-off state and the supply state, when the switch apparatus switches the shut-off state to the supply state.

### TECHNICAL FIELD

The present disclosure relates to a display system of a work machine.

### BACKGROUND ART

A system for controlling a display apparatus of a work machine is disclosed for example in Japanese Patent Laying-Open No. 2018-105064 (PTL 1). According to PTL 1, operation of the work machine through manipulation of an operation apparatus is permitted, when the display apparatus shows a surroundings image. In contrast, operation of the work machine through manipulation of the operation apparatus is inhibited, when the display apparatus does not show a surroundings image.

### CITATION LIST

### Patent Literature

PTL 1: Japanese Patent Laying-Open No. 2018-105064

### SUMMARY OF INVENTION

### Technical Problem

In recent years, operational control of a work machine has become complicated and sophisticated. It is therefore desired to simplify setting of operational properties by means of a display apparatus of the work machine.

In view of the above, an object of the present disclosure is to provide a display system of a work machine for which setting of operational properties by means of a display apparatus is facilitated.

### Solution to Problem

A display system of a work machine in the present disclosure includes an actuator, a switch apparatus, a display apparatus, and a controller. The actuator drives the work machine. The switch apparatus makes a switch between a supply state in which the actuator can be driven and a shut-off state in which the actuator cannot be driven. The display apparatus is capable of switching between displaying a setting screen for setting an operational property of the actuator and displaying an information display screen different from the setting screen, in the shut-off state. The controller performs control to cause the display apparatus to continue displaying the setting screen, when the switch apparatus switches the shut-off state to the supply state.

### Advantageous Effects of Invention

According to the present disclosure, a display system of a work machine, for which setting of operational properties by means of a display apparatus is facilitated, can be implemented.

### BRIEF DESCRIPTION OF DRAWINGS

FIG. 1 is a perspective view schematically showing a configuration of a work machine according to one embodiment of the present disclosure.

FIG. 2 shows a configuration of a display system of the work machine shown in FIG. 1.

FIG. 3 shows one example of functional blocks of the display system shown in FIG. 2.

FIG. 4 is a flowchart showing one example of a display method for the work machine according to one embodiment of the present disclosure.

FIG. 5 shows a first screen (initial screen) displayed on a display apparatus.

FIG. 6 shows a second screen (selection screen) displayed on the display apparatus.

FIG. 7 shows a third screen (setting screen) displayed on the display apparatus.

### DESCRIPTION OF EMBODIMENTS

Embodiments of the present disclosure are described hereinafter based on the drawings.

In the specification and the drawings, the same or corresponding components are denoted by the same reference characters, and a description thereof is not herein repeated. In the drawings, some components may not be shown or may be simplified for the sake of convenience of illustration.

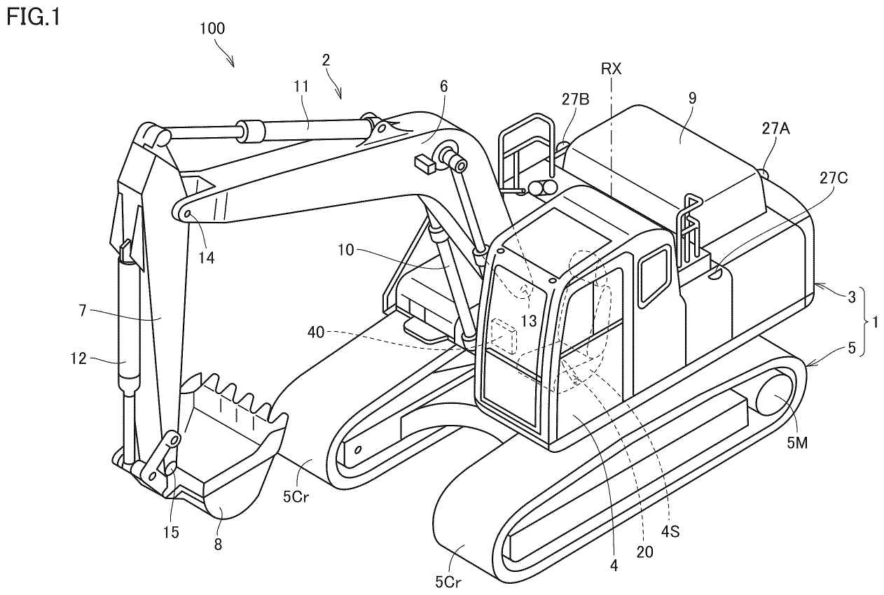

In connection with the present embodiment, a hydraulic excavator, which is an example of work machines, is described. The present disclosure, however, is also applicable to work machines such as wheel loader, crawler dozer, and motor grader, besides the hydraulic excavator. In the following description, “upward,” “downward/under,” “front,” “rear”, “left” and “right” each refer to a direction with respect to an operator (driver) sitting on an operator's seat 4S in an operator's cab 4 shown in FIG. 1.

<Configuration of Work Machine>

First, a configuration of a work machine according to the present embodiment is described with reference to FIG. 1.

FIG. 1 is a perspective view schematically showing a configuration of a work machine according to one embodiment of the present disclosure. As shown in FIG. 1, work machine 100 according to the present embodiment is a hydraulic excavator, for example.

Hydraulic excavator 100 includes a main body 1 and a work implement 2 that is hydraulically actuated. Main body 1 includes a revolving unit 3 and a traveling unit 5. Traveling unit 5 includes a pair of crawler belts 5Cr and a travel motor 5M. Rotation of crawler belts 5Cr enables hydraulic excavator 100 to travel. Travel motor 5M is provided as a driving source for traveling unit 5. Travel motor 5M is a hydraulic motor that is hydraulically actuated. Traveling unit 5 may include wheels (tires).

Revolving unit 3 is disposed on traveling unit 5 and supported by traveling unit 5. Revolving unit 3 is enabled to revolve about a revolution axis RX by a revolution motor (not shown), with respect to traveling unit 5. Revolving unit 3 includes operator's cab 4.

In operator's cab 4, operator's seat 4S on which an operator is to sit is provided. An operator onboard operator's cab 4 can manipulate work implement 2, manipulate revolving unit 3 to revolve with respect to traveling unit 5, and manipulate hydraulic excavator 100 to travel by means of traveling unit 5.

Revolving unit 3 includes an engine cover 9 and a counterweight provided in a rear part of revolving unit 3. Engine cover 9 covers an engine compartment. In the engine compartment, an engine unit (engine, exhaust gas processing device, for example) are disposed.

Work implement 2 is supported by revolving unit 3. Work implement 2 includes a boom 6, a dipper stick 7, and a bucket 8. Work implement 2 further includes a boom cylinder 10, a dipper stick cylinder 11, and a bucket cylinder 12.

Boom 6 is pivotally connected to main body 1 (traveling unit 5 and revolving unit 3). Specifically, the proximal end of boom 6 is pivotally connected to revolving unit 3 with a boom hood pin 13 serving as a fulcrum.

Dipper stick 7 is pivotally connected to boom 6. Specifically, the proximal end of dipper stick 7 is pivotally connected to the distal end of boom 6, with a boom top pin 14 serving as a fulcrum. Bucket 8 is pivotally connected to dipper stick 7. Specifically, the proximal end of bucket 8 is pivotally connected to the distal end of dipper stick 7 with a dipper stick top pin 15 serving as a fulcrum.

One end of boom cylinder 10 is connected to revolving unit 3 and the other end thereof is connected to boom 6. Boom 6 can be driven by boom cylinder 10 with respect to main body 1. Boom 6 can thus be driven to pivot upward/downward with respect to revolving unit 3, with boom hood pin 13 serving as a fulcrum.

One end of dipper stick cylinder 11 is connected to boom 6 and the other end thereof is connected to dipper stick 7. Dipper stick 7 can be driven with respect to boom 6 by dipper stick cylinder 11. Dipper stick 7 can thus be driven to pivot upward/downward or fore/aft direction with respect to boom 6, with boom top pin 14 serving as a fulcrum.

One end of bucket cylinder 12 is connected to dipper stick 7, and the other end thereof is connected to a bucket link. Bucket 8 can be driven with respect to dipper stick 7 by bucket cylinder 12. Bucket 8 can thus be driven to pivot upward/downward with respect to dipper stick 7, with dipper stick top pin 15 serving as a fulcrum.

In operator's cab 4, a display apparatus 40 is disposed. An operator sitting on operator's seat 4s in operator's cab 4 can visually recognize a display unit (display screen) of display apparatus 40. Display apparatus 40 may include a touch panel, for example. In this case, an operator can manipulate the touch panel of display apparatus 40 through touching. Through the touching manipulation, an image displayed on display apparatus 40 can be changed, and operational properties of the actuator (cylinders 10 to 12, travel motor 5M, revolution motor, for example) can be set, for example.

<Configuration of Display System>

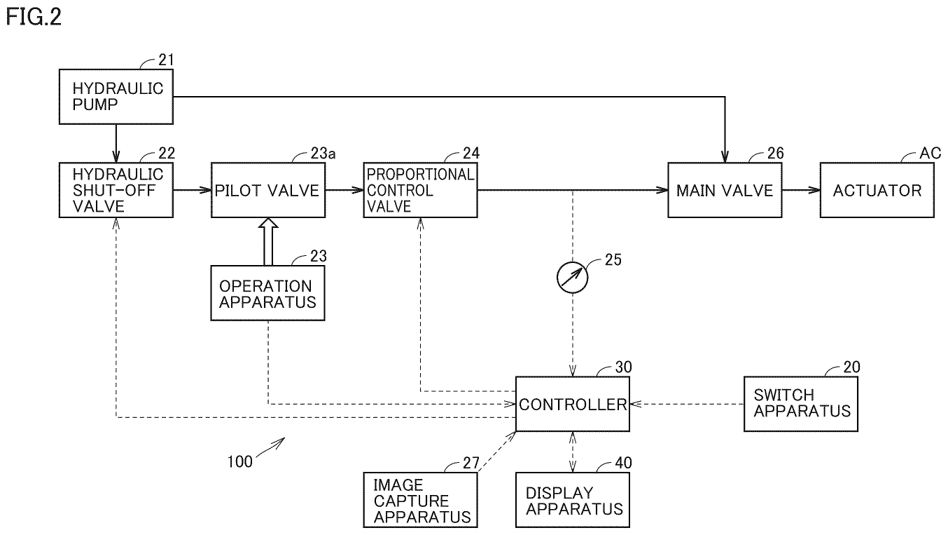

Next, a configuration of a display system according to the present embodiment is described with reference to FIG. 2.

FIG. 2 shows a configuration of a display system of the work machine shown in FIG. 1. As shown in FIG. 2, hydraulic excavator 100 includes a switch apparatus 20, a controller 30, display apparatus 40, an operation apparatus 23, an image capture apparatus 27, and a hydraulic circuit extending from a hydraulic pump 21 to an actuator AC. Solid-line arrows in FIG. 2 represent the hydraulic circuit, and broken-line arrows represent an electrical circuit.

Image capture apparatus 27 is attached to revolving unit 3, for example. Image capture apparatus 27 is a camera, for example, and may be a stereo camera. Image capture apparatus 27 may include a plurality of cameras (a rear camera 27A, a right-side camera 27B, and a left-side camera 27C (FIG. 1), for example) for capturing respective images of frontward, rearward, right side, and left side areas of hydraulic excavator 100, for example.

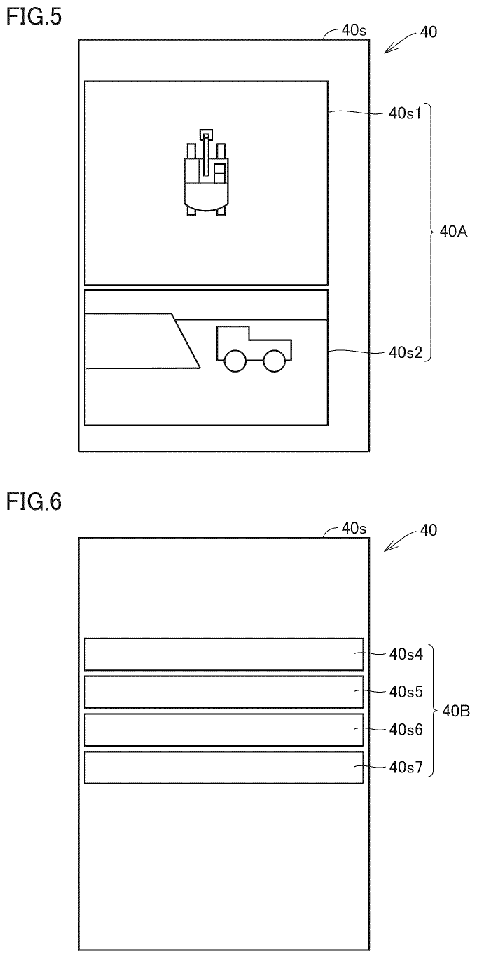

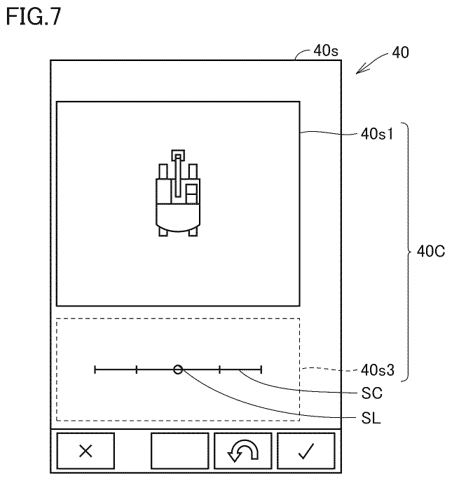

Display apparatus 40 includes the display unit for displaying images. The display unit is capable of switching between displaying a first screen (FIG. 5), displaying a second screen (FIG. 6), displaying a third screen (FIG. 7), and displaying a fourth screen (not shown), for example.

Controller 30 controls what is displayed on display apparatus 40. Controller 30 controls display apparatus 40 to cause display apparatus 40 to selectively display the first screen, the second screen, the third screen, or the fourth screen, for example. Controller 30 controls overall operation of hydraulic excavator 100. Controller 30 is a concept including both a monitor controller and a vehicular body controller.

Operation apparatus 23 is manipulated by an operator to cause hydraulic excavator 100 to operate. Operation apparatus 23 includes, for example, a control lever for manipulating work implement 2, a control lever for causing revolving unit 3 to revolve, and a pedal for causing traveling unit 5 to travel, for example.

The hydraulic circuit includes hydraulic pump 21, a hydraulic shut-off valve 22, a pilot valve 23a, a proportional control valve 24, a pressure sensor 25, a main valve 26, and actuator AC.

Hydraulic pump 21 is driven by power transmitted from the engine to discharge pressurized oil. Hydraulic pump 21 includes a hydraulic oil source and a pilot oil source. The pressurized oil discharged from hydraulic pump 21 includes hydraulic oil for driving actuator AC and pilot oil for moving a spool of main valve 26.

The hydraulic oil discharged from hydraulic pump 21 is supplied from hydraulic pump 21 to actuator AC through main valve 26. This hydraulic ail causes actuator AC to be driven.

The pilot oil discharged from hydraulic pump 21 is supplied to main valve 26 through hydraulic shut-off valve 22, pilot valve 23a, and proportional control valve 24 in this order.

Hydraulic shut-off valve 22 receives a command signal from controller 30 to be switched either to a supply state or a shut-off state. In the supply state, hydraulic shut-off valve 22 supplies the pilot oil to pilot valve 23a. Thus, in the supply state, actuator AC can be driven through manipulation of operation apparatus 23 by an operator.

In the shut-off state, hydraulic shut-off valve 22 shuts off flow of the pilot oil so as not to supply the pilot oil to pilot valve 23a. Thus, in the shut-off state, actuator AC cannot be driven through manipulation of operation apparatus 23 by an operator.

Pilot valve 23a is caused to operate through manipulation of operation apparatus 23 by an operator. Based on the amount of manipulation of operation apparatus 23, pilot valve 23a adjusts the pressure of the pilot oil. The pilot oil with its pressure adjusted by pilot valve 23a is supplied to main valve 26 through proportional control valve 24. Thus, main valve 26 is caused to operate based on the amount of manipulation of operation apparatus 23 by an operator. Accordingly, driving of actuator AC can be controlled based on the amount of manipulation of operation apparatus 23 by an operator.

Proportional control valve 24 is caused to operate based on a control signal from controller 30. Proportional control valve 24 operates to control the pressure of the pilot oil and thereby control operation of main valve 26. Thus, based on a control signal from controller 30, driving of actuator AC can be controlled.

Pressure sensor 25 is disposed downstream of proportional control valve 24 to detect a pressure variation of the pilot oil having passed through proportional control valve 24. The result of detection by pressure sensor 25 is output to controller 30.

Main valve 26 includes the spool. The spool of main valve 26 is moved by the pressure of the pilot oil. Movement of the spool controls the amount of the hydraulic oil supplied to actuator AC.

Actuator AC may for example be any of hydraulic cylinders 10 to 12 that drive boom 6, dipper stick 7, and bucket 8, or the revolution motor that causes revolving unit 3 to revolve, or travel motor 5M that drives traveling unit 5. Instead of bucket 8, any of other tools (attachments) may be used.

The amount of manipulation of operation apparatus 23 may be detected by pressure sensor 25. The amount of manipulation of operation apparatus 23 may also be detected by means of a potentiometer that detects the angle of manipulation of the control lever of operation apparatus 23. A signal representing the amount of manipulation of operation apparatus 23 is output to controller 30.

Switch apparatus 20 is an apparatus to switch hydraulic shut-off valve 22 between the supply state and the shut-off state, and is a lock lever, for example. Switch apparatus 20 may also be a switch or a seat sensor, instead of the lock lever. Switch apparatus 20 is electrically connected to controller 30. For switch apparatus 20, a switching manipulation is performed by an operator. In response to the switching manipulation performed by the operator, switch apparatus 20 outputs a switch signal to controller 30.

Receiving the switch signal from switch apparatus 20, controller 30 controls operation of hydraulic shut-off valve 22, based on the signal. Receiving, from switch apparatus 20, the switch signal to switch the shut-off state to the supply state, controller 30 controls hydraulic shut-off valve 22 to switch from shut-off state to the supply state. Receiving, from switch apparatus 20, the switch signal to switch the supply state to the shut-off state, controller 30 controls hydraulic shut-off valve 22 to switch from the supply state to the shut-off state.

<Screens Displayed on Display Apparatus 40>

Next, screens displayed on display apparatus 40 are described with reference to FIGS. 5 to 7.

FIGS. 5, 6, and 7 show a first screen (initial screen), a second screen (selection screen), and a third screen (setting screen) respectively that are displayed on the display apparatus. As shown in FIG. 5, first screen (initial screen) 40A is displayed on a display unit 40s of display apparatus 40. First screen 40A is, for example, an initial screen (standard screen) that is displayed when work machine 100 is actuated.

First screen 40A is, for example, a captured image generated by means of image capture apparatus 27 (FIG. 2). First screen 40A includes a bird's eye view image 40s1. Bird's eye view image 40s1 is generated from a plurality of images captured respectively by the front camera, the rear camera, the right side camera, and the left side camera, for example, and synthesized by controller 30.

Bird's eye view image 40s1 is an image as viewed from above toward hydraulic excavator 100. An operator can recognize, through bird's eye view image 40s1, situations of hydraulic excavator 100 and the surroundings of hydraulic excavator 100.

First screen 40A also includes a single camera image 40s2. Single camera image 40s2 is an image generated by capturing an image of any one of frontward, rearward, right side, and left side areas of hydraulic excavator 100, for example, captured by a single image capture apparatus 27. Single camera image 40s2 may also be an image captured by a stereo camera.

First screen 40A may include both of bird's eye view image 40s1 and single camera image 40s2. In this case, bird's eye view image 40s1 and single camera image 40s2 may be arranged side by side either vertically or laterally on display unit 40s of display apparatus 40. In the present embodiment, bird's eye view image 40s1 is disposed upward of single camera image 40s2.

As shown in FIG. 6, second screen (selection screen) 40B is displayed on display unit 40s of display apparatus 40. Second screen 40B, which is a user menu screen for example, is a selection screen for selecting one item from a plurality of items.

Second screen 40B includes a plurality of image select buttons 40s4 to 40s7, for example. A plurality of image select buttons 40s4 to 40s7 include a button for selecting displaying the third screen and a button for selecting displaying the fourth screen, for example.

When an operator touches the button for selecting displaying the third screen, the screen displayed on display apparatus 40 is switched from second screen 40B to the third screen (FIG. 7). When an operator touches the button for selecting displaying the fourth screen, the screen displayed on display apparatus 40 is switched from second screen 40B to the fourth screen (not shown).

As shown in FIG. 7, third screen (setting screen) 40C is displayed on display unit 40s of display apparatus 40. Third screen 40C includes a setting image 40s3 for setting an operational property of actuator AC. This is a screen for setting, for example, an operational property of actuator AC.

In the case where actuator AC is driven by hydraulic oil, for example, setting screen 40C is a screen for an operator to set the property of the flow rate of hydraulic oil supplied to actuator AC.

Setting screen 40C may also be a screen for setting the balance between revolution of revolving unit 3 and lifting operation of boom 6 during a hoisting and revolving movement, for example. This screen is specifically a screen for an operator to set the lifting speed of boom 6 with respect to the revolving speed of revolving unit 3 during a hoisting and revolving movement. This setting is made by adjusting the amount of hydraulic oil supplied to each of the revolution motor that causes revolving unit 3 to revolve, and boom cylinder 10.

Setting screen 40C may also be a screen for setting the maximum operational speed of each of one or more members selected from the group consisting of revolving unit 3, boom 6, dipper stick 7, and bucket 8, for example. The setting of the maximum operational speed is made by adjusting the amount of hydraulic oil supplied to each of the revolution motor that causes revolving unit 3 to revolve, boom cylinder 10, dipper stick cylinder 11, and bucket cylinder 12.

Setting screen 40C may also be a screen for setting the responsiveness of actuator AC to operation apparatus 23, for example. This screen is specifically a screen for setting the operational speed or the operational amount of actuator AC in response to the amount of manipulation of operation apparatus 23. The setting of the responsiveness is made by adjusting the amount of hydraulic oil supplied to actuator AC with respect to the amount of manipulation of operation apparatus 23.

The adjustment of the amount of hydraulic oil is made by changing the amount of movement, per unit time, of the spool of main valve 26, to change the degree of opening of the port, for example.

In the case where each part is calibrated, setting screen 40C may also be a screen for setting calibration. Setting screen 40C may specifically be a screen for calibrating an error of an IMU (Inertial Measurement Unit) attached to hydraulic excavator 100. Setting screen 40C may also be a screen for calibrating an error in weight, dimension, or the like, for ICT (Information and Communication Technology) control, resultant from replacement of a work tool (attachment) such as bucket 8. Setting screen 40C may also be a screen for calibrating an error in payload measurement, resultant from replacement of a work tool (attachment) such as bucket 8.

Third screen 40C includes a setting image 40s3 for setting an operational property of actuator AC. Setting image 40s3 includes an image in which a scale SC and a slider SL are combined, for example. An operator can slide slider SL along scale SC to change the operational property of actuator AC.

Third screen 40C may include a captured image 40s1. Captured image 40s1 is, for example, a bird's eye view image. Setting image 40s3 and captured image 40s1 may be arranged side vertically on display unit 40s. In this case, setting image 40s3 may be located under captured image 40s1.

The fourth screen (information display screen) is also displayed on display unit 40s of display apparatus 40. The fourth screen is a screen different from each of first screen 40A, second screen 40B, and third screen 40C. The fourth screen is an information display screen for displaying information about hydraulic excavator 100, for example. The fourth screen includes, for example, an image indicating operational information such as operation record and fuel consumption history, for example, of hydraulic excavator 100.

<Configuration of Functional Blocks of Display System>

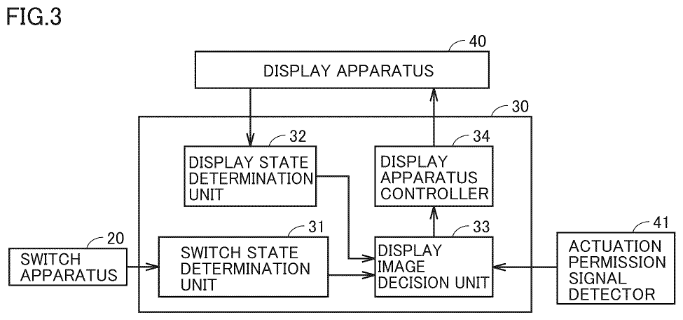

Next, a configuration of functional blocks of the display system shown in FIG. 2 is described with reference to FIG. 3.

FIG. 3 shows one example of functional blocks of the display system shown in FIG. 2. As shown in FIG. 3, controller 30 includes a switch state determination unit 31, a display state determination unit 32, a display image decision unit 33, and a display apparatus controller 34.

Switch state determination unit 31 obtains a switch signal which is output from switch apparatus 20. Switch state determination unit 31 determines whether the switch signal output from switch apparatus 20 is a signal instructing switching from the shut-off state to the supply state, or a signal instructing switching from the supply state to the shut-off state. Switch state determination unit 31 outputs a signal representing a result of the determination, to display image decision unit 33.

Display state determination unit 32 obtains, from display apparatus 40, a signal representing the current display state. Display state determination unit 32 determines whether the image currently displayed on display apparatus 40 is first screen 40A, second screen 40B, third screen 40C, or the fourth screen. Display state determination unit 32 outputs a signal representing a result of the determination, to display image decision unit 33.

In the case where display apparatus 40 is a touch panel, display state determination unit 32 obtains a manipulation signal generated through operator's touch manipulation of display apparatus 40. For example, when an operator touches a button on second screen 40B for selecting one of displaying third screen 40C and displaying the fourth screen, display state determination unit 32 obtains a signal for displaying third screen 40C and the fourth screen.

Display image decision unit 33 obtains the signal representing a result of the determination regarding the switch state of switch apparatus 20, and the signal representing a result of the determination regarding the display state of display apparatus 40. Display image decision unit 33 also obtains an actuation permission signal from an actuation permission signal detector 41.

When hydraulic excavator 100 is actuated, actuation permission signal detector 41 detects the actuation of hydraulic excavator 100, to output the actuation permission signal to display image decision unit 33. Hydraulic excavator 100 may be actuated by one of or any combination of insertion of a key, manipulation of an actuation button, and input of a password, for example.

Based on respective signals obtained from switch state determination unit 31, display state determination unit 32, and actuation permission signal detector 41, display image decision unit 33 decides that an image is to be displayed on display apparatus 40. When display image decision unit 33 decides that the image is to be displayed on display apparatus 40, display image decision unit 33 outputs, to display apparatus controller 34, a signal representing the image.

When display image decision unit 33 obtains the actuation permission signal from actuation permission signal detector 41, display image decision unit 33 outputs, to display apparatus controller 34, a signal for displaying first screen (initial screen) 40A. When display image decision unit 33 obtains a switch signal indicating that switch apparatus 20 has switched the supply state to the shut-off state, while display apparatus 40 displays first screen 40A, display image decision unit 33 outputs, to display apparatus controller 34, a signal for displaying second screen (selection screen) 40B.

When display image decision unit 33 obtains a selection signal indicating that third screen (setting screen) 40C has been selected from display apparatus 40, while display apparatus 40 displays second screen 40B, display image decision unit 33 outputs, to display apparatus controller 34, a signal for displaying third screen 40C.

When display image decision unit 33 obtains a selection signal indicating that the fourth screen (information display screen) has been selected from display apparatus 40, while display apparatus 40 displays second screen 40B, display image decision unit 33 outputs, to display apparatus controller 34, a signal for displaying the fourth screen.

When display image decision unit 33 obtains a switch signal indicating that switch apparatus 20 has switched the shut-off state to the supply state, while display apparatus 40 displays third screen (setting screen) 40C, display image decision unit 33 outputs, to display apparatus controller 34, a signal for continuing displaying third screen 40C even after switching to the supply state.

When display image decision unit 33 obtains a switch signal indicating that switch apparatus 20 has switched the shut-off state to the supply state, while display apparatus 40 displays the fourth screen (information display screen), display image decision unit 33 outputs, to display apparatus controller 34, a signal for displaying another screen other than the fourth screen.

Display apparatus controller 34 obtains, from display image decision unit 33, a signal representing the screen decided to be displayed. Display apparatus controller 34 controls display apparatus 40 to display the screen, based on the obtained signal representing the screen. Thus, any of first screen 40A, second screen 40B, third screen 40C, and the fourth screen is displayed on display apparatus 40.

<Display Method>

Next, a method for display by the display system is described with reference to FIGS. 2 to 10.

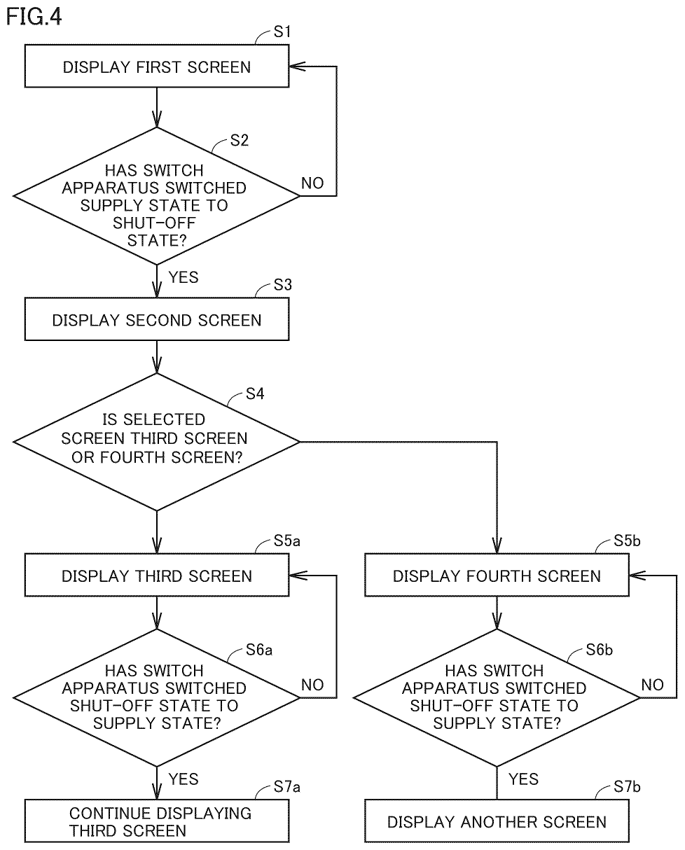

FIG. 4 is a flowchart showing one example of a display method for the work machine according to one embodiment of the present disclosure. As shown in FIGS. 3 and 4, an actuation permission signal is sent by an operator to hydraulic excavator 100. When the actuation permission signal is sent, actuation permission signal detector 41 outputs the actuation permission signal to display image decision unit 33.

When display image decision unit 33 obtains the actuation permission signal from actuation permission signal detector 41, display image decision unit 33 outputs, to display apparatus controller 34, a signal for displaying first screen 40A which is an initial image. Based on the obtained signal, display apparatus controller 34 controls display apparatus 40 to display first screen 40A. Thus, first screen 40A as shown in FIG. 5 is displayed on display unit 40s of display apparatus 40 (step S1, FIG. 4).

In this state, an operator manipulates hydraulic excavator 100 while recognizing the surroundings of hydraulic excavator 100 on first screen 40A. At this time, switch state determination unit 31 determines whether or not switch apparatus 20 has switched the supply state to the shut-off state (step S2, FIG. 4). When switch apparatus 20 has not yet switched the supply state to the shut-off state, switch state determination unit 31 repeatedly determines whether or not switch apparatus 20 has switched the supply state to the shut-off state (step S2, FIG. 4).

When switch state determination unit 31 determines that switch apparatus 20 has switched the supply state to the shut-off state, switch state determination unit 31 outputs a signal representing the determination to display image decision unit 33. When display image decision unit 33 obtains the signal indicating that switch apparatus 20 has switched the supply state to the shut-off state, while display apparatus 40 displays first screen 40A, display image decision unit 33 decides that second screen 40B is to be displayed on display apparatus 40. Based on a signal from display image decision unit 33, display apparatus controller 34 controls display apparatus 40 to display second screen 40B. Thus, second screen 40B as shown in FIG. 6 is displayed on display unit 40s of display apparatus 40 (step S3, FIG. 4).

As shown in FIG. 6, a plurality of image select buttons 40s4 to 40s7 are displayed on second screen 40B. A plurality of image select buttons 40s4 to 40s7 include a button for selecting display of third screen 40C and a button for selecting display of the fourth screen, for example.

When an operator touches the button for selecting display of third screen 40C, a signal indicating that third screen 40C has been selected is output from display apparatus 40 to display state determination unit 32. When an operator touches the button for selecting display of the fourth screen, a signal indicating that the fourth screen has been selected is output from display apparatus 40 to display state determination unit 32.

Based on the signal from display apparatus 40, display state determination unit 32 determines whether the selected screen is third screen 40C or the fourth screen (step S4, FIG. 4). Display state determination unit 32 outputs, to display image decision unit 33, a signal representing a result of the determination.

When display state determination unit 32 determines that third screen 40C has been selected, display image decision unit 33 decides that third screen 40C is to be displayed, and outputs a signal representing the specified image to be displayed, to display apparatus controller 34. Thus, third screen 40C as shown in FIG. 7 is displayed on display unit 40s of display apparatus 40 (step S5a, FIG. 4).

Switch state determination unit 31 determines whether or not switch apparatus 20 has switched the shut-off state to the supply state, while third screen 40C is displayed on display unit 40s of display apparatus 40 (step S6a). When switch state determination unit 31 determines that the shut-off state has not been switched to the supply state, third screen 40C is displayed on display unit 40s of display apparatus 40. When switch state determination unit 31 determines that the shut-off state has been switched to the supply state, third screen 40C continues being displayed on display unit 40s of display apparatus 40 (step S7a, FIG. 4).

In this case, switch state determination unit 31 outputs, to display image decision unit 33, a signal indicating the determination that the shut-off state has been switched to the supply state. Based on the signal indicating the determination from switch state determination unit 31, display image decision unit 33 decides that third screen 40C is to continue being displayed, and outputs a signal representing the decision to display apparatus controller 34. Based on the signal representing the decision from display image decision unit 33, display apparatus controller 34 controls display unit 40s of display apparatus 40 to continue displaying third screen 40C.

In contrast, when display state determination unit 32 determines in step S4 that the fourth screen has been selected, display image decision unit 33 decides that the fourth screen is to be displayed and outputs a signal representing the specified image to be displayed, to display apparatus controller 34. Thus, the fourth screen is displayed on display unit 40s of display apparatus 40 (step S5b, FIG. 4).

Switch state determination unit 31 determines whether or not switch apparatus 20 has switched the shut-off state to the supply state, while the fourth screen is displayed on display unit 40s of display apparatus 40 (step S6b). When switch state determination unit 31 determines that the shut-off state has not yet been switched to the supply state, the fourth screen is displayed on display unit 40s of display apparatus 40. When switch state determination unit 31 determines that the shut-off state has been switched to the supply state, another screen other than the fourth screen is displayed on display unit 40s of display apparatus 40 (step S7b, FIG. 4).

In this case, switch state determination unit 31 outputs, to display image decision unit 33, a signal indicating the determination that the shut-off state has been switched to the supply state. Based on the signal indicating the determination from switch state determination unit 31, display image decision unit 33 decides that another screen other than the fourth screen is to be displayed, and outputs a signal representing the decision to display apparatus controller 34. Based on the signal representing the decision from display image decision unit 33, display apparatus controller 34 controls display unit 40s of display apparatus 40 to display the other screen. The screen may be the first screen or an image other than the first screen. Alternatively, the fourth screen may continue being displayed.

<Advantageous Effects>

Next, advantageous effects of the present embodiment are described.

In the present embodiment, as shown in FIGS. 3 and 4, when the shut-off state is switched to the supply state by switch apparatus 20 while third screen (setting screen) 40C is displayed on display apparatus 40, third screen 40C continues being displayed on display apparatus 40 in both the shut-off state and the supply state. Thus, when the switch apparatus 20 switches the shut-off state to the supply state after an operational property of actuator AC is set, to cause hydraulic excavator 100 to operate for a try, display apparatus 40 continues displaying third screen (setting screen) 40C and the screen is not switched to another screen. Therefore, even when the operational property of actuator AC is to be set again, it is unnecessary for switch apparatus 20 to switch the supply state to the shut-off state again. Setting of the operational property by means of display apparatus 40 is thus facilitated.

In the present embodiment, as shown in FIG. 4, when switch apparatus 20 switches the state to the supply state while the fourth screen (information display screen) is displayed on display apparatus 40 in the shut-off state, the fourth screen is switched to another screen (steps S6b, S7b). Thus, first screen 40A can be displayed as the other screen on display apparatus 40, for example, when actuator AC is manipulated.

In the present embodiment, third screen 40C is an image for setting the flow rate property of actuator AC. Thus, setting of the operational property of actuator AC which is hydraulically operated, is facilitated.

In the present embodiment, third screen 40C is an image for setting the balance between revolution of revolving unit 3 and lifting operation of boom 6, during operation in which boom 6 is lifted while revolving unit 3 is revolved. Thus, setting of the balance between revolution of revolving unit 3 and lifting operation of boom 6 during a hoisting and revolving movement is facilitated.

In the present embodiment, third screen 40C is an image for setting the maximum operational speed of each of one or more members selected from the group consisting of revolving unit 3, boom 6, dipper stick 7, and bucket 8. Thus, setting of the maximum operational speed of the member(s) is facilitated.

In the present embodiment, third screen 40C is an image for setting the responsiveness of actuator AC to operation apparatus 23. Thus, setting of the responsiveness of actuator AC to operation apparatus 23 is facilitated.

In the present embodiment, as shown in FIG. 7, controller 30 controls display apparatus 40 to display captured image 40s1 which is captured by image capture apparatus 27, together with setting image 40s3. Thus, when the operational property of actuator AC is set, the surroundings of work machine 100 can be recognized on captured image 40s1.

When the operational property of actuator AC is set by means of third screen 40C, work machine 100 may operate beyond what is expected by an operator. In the present embodiment, as shown in FIG. 7, the captured image displayed simultaneously with setting image 40s3 includes bird's eye view image 40s1 obtained by capturing the surroundings of work machine 100. Thus, an operator can manipulate work machine 100 while recognizing, on bird's eye view image 40s1, the operation of work machine 100 and the surroundings of work machine 100, after the operational property of actuator AC is set.

If the captured image and the setting image are displayed simultaneously on display unit 40s of display apparatus 40 and the setting image is displayed upward of the captured image, the captured image may be hidden by a hand of an operator touching the setting image and thus difficult to see.

In contrast, in the present embodiment as shown in FIG. 7, controller 30 performs control to display setting image 40s3 under captured image 40s1. Thus, when an operator touches setting image 40s3, captured image 40s1 is prevented from becoming difficult to see.

While the present embodiment is described above in connection with the case where the amount of manipulation by operation apparatus 23 is detected based on a pilot hydraulic system, as shown in FIG. 2, the amount of manipulation by operation apparatus 23 may also be detected based on an electrical system. In this case, the amount of manipulation by operation apparatus 23 is detected by a potentiometer or the like, and output, in the form of an electrical signal, to controller 30.

While actuator AC shown in FIG. 2 is described above as a hydraulic actuator which is driven hydraulically, actuator AC may also be an electric actuator driven electrically, such as electric cylinder and electric motor. In this case, switch apparatus 20 may shut off an electrical signal or electric power from an electric drive source to electric actuator AC.

The operational property is the property of the flow rate of oil if actuator AC is hydraulic actuator, and is the electric power property if actuator AC is electric actuator.

When actuator AC is electrically driven, for example, setting screen 40C is an image on which an operator sets the property of electric power supplied to actuator AC.

Controller 30 shown in each of FIGS. 2 and 3 in the above-described embodiment may be mounted on hydraulic excavator 100 or located away from hydraulic excavator 100. When controller 30 is located away from hydraulic excavator 100, controller 30 may be connected wirelessly to switch apparatus 20, operation apparatus 23, proportional control valve 24, pressure sensor 25, display apparatus 40, and actuation permission signal detector 41, for example. Controller 30 may for example be a processor, and may be a CPU (Central Processing Unit).

While display apparatus 40 described in connection with the above embodiment is disposed in operator's cab 4 as shown in FIG. 1, display apparatus 40 may be disposed outside operator's cab 4. Display apparatus 40 may also be located away from hydraulic excavator 100.

Hydraulic excavator 100 may be manipulated remotely. In this case, display apparatus 40 and operation apparatus 23 for example are disposed at a location remote from hydraulic excavator 100. Hydraulic excavator 100 is manipulated through wirelessly-received manipulation commands that are output from display apparatus 40 and operation apparatus 23 for example.

While work tool 8 described above is a bucket, work tool 8 may for example be a breaker, fine crusher, rough crusher, auger screw, grapple, or the like.

It should be construed that the embodiments disclosed herein are given by way of illustration in all respects, not by way of limitation. It is intended that the scope of the present invention is defined by claims, not by the description above, and encompasses all modifications equivalent in meaning and scope to the claims.

### REFERENCE SIGNS LIST

1 main body; 2 work implement; 3 revolving unit; 4 operator's cab; 4S operator's seat; 5 traveling unit; 5Cr crawler belt; 5M travel motor; 6 boom; 7 dipper stick; 8 bucket (work tool); 9 engine cover; 10 boom cylinder; 11 dipper stick cylinder; 12 bucket cylinder; 13 boom hood pin; 14 boom top pin; 15 dipper stick top pin; 20 switch apparatus; 21 hydraulic pump; 22 hydraulic shut-off valve; 23 operation apparatus; 23a pilot valve; 24 proportional control valve; 25 pressure sensor; 26 main valve; 27 image capture apparatus; 27A rear camera; 27B right side camera; 27C left side camera; 30 controller; 31 switch state determination unit; 32 display state determination unit; 33 display image decision unit; 34 display apparatus controller; 40 display apparatus; 40A first screen (initial image); 40B second screen (selection image); 40C third screen (setting screen); 40s display unit; 40s1 bird's eye view image; 40s2 single camera image; 40s3 setting image; 40s4 to 40s7 image select button; 41 actuation permission signal detector; 100 work machine (hydraulic excavator); AC actuator; RX revolution axis; SC scale; SL slider

1: A display system of a work machine, the display system comprising:
an actuator that drives the work machine;
a switch apparatus that makes a switch between a supply state in which the actuator can be driven and a shut-off state in which the actuator cannot be driven;
a display apparatus capable of switching between displaying a setting screen for setting an operational property of the actuator and displaying an information display screen different from the setting screen, in the shut-off state; and
a controller that performs control to cause the display apparatus to continue displaying the setting screen, when the switch apparatus switches the shut-off state to the supply state.

2: The display system of the work machine according to claim 1, wherein the setting screen is a screen for setting a flow rate property of the actuator.

3: The display system of the work machine according to claim 2, wherein
the work machine further comprises:
a revolving unit; and
a boom pivotally connected to the revolving unit, and
the setting screen includes an image for setting balance between revolution of the revolving unit and lifting operation of the boom during a hoisting and revolving movement.

4: The display system of the work machine according to claim 2, wherein
the work machine further comprises:
a revolving unit;
a boom pivotally connected to the revolving unit;
a dipper stick pivotally connected to the boom; and
a work tool pivotally connected to the dipper stick, and
the setting screen includes an image for setting a maximum operational speed of one or more members selected from the group consisting of the revolving unit, the boom, the dipper stick, and the work tool.

5: The display system of the work machine according to claim 2, wherein
the work machine further comprises an operation apparatus that manipulates the actuator, and
the setting screen includes an image for setting responsiveness of the actuator to the operation apparatus.

6: The display system of the work machine according to claim 1, wherein
the display system further comprises an image capture apparatus, and
the controller performs control to cause the display apparatus to display the setting screen, the setting screen including a captured image captured by the image capture apparatus and a setting image for setting an operational property of the actuator.

7: The display system of the work machine according to claim 6, wherein the controller performs control to cause the display apparatus to display, as the captured image, a bird's eye view image generated by capturing surroundings of the work machine.

8: The display system of the work machine according to claim 6, wherein the controller controls the display apparatus to cause the display apparatus to display the setting image under the captured image.

9: The display system of the work machine according to claim 1, wherein when a switch signal for switching the shut-off state to the supply state is input from the switch apparatus to the controller while the information display screen is displayed on the display apparatus in the shut-off state, the controller performs control to cause the display apparatus to switch from displaying the information display screen to displaying another screen other than the information display screen.
